(19) United States
(12) Patent Application Publication
(10) Pub. No.: US 2009/0043662 A1
(43) Pub. Date: Feb. 12, 2009

(54) Method of operating an economic enterprise in which cognitive reserve is enhanced

(76) Inventor: Roger Leslie Maxwell, Dallas, TX (US)

Correspondence Address: Roger L. Maxwell, 3221 Amherst Avenue, Dallas, TX, 75225, US

(21) Appl. No.: 11/890,705

(22) Filed: Aug. 7, 2007

(51) Int. Cl. G06Q 30/00; G06Q 90/00

(52) U.S. Cl. 705/15

(57) ABSTRACT

A business entity provides nutrition, physical and mental activities to enhance the cognitive reserves of people. The business entity can assess the cognitive reserve of people to assist in this process. The business entity can present information to people to assist in its work.

### CROSS-REFERENCE TO RELATED APPLICATIONS

None.

### STATEMENT REGARDING FEDERALLY SPONSORED RESEARCH AND DEVELOPMENT

Federally sponsored research and development is not involved here.

### THE NAMES OF A PARTIES TO A JOINT RESEARCH AGREEMENT

Not applicable.

### REFERENCE TO A “SEQUENCE LISTING,” A TABLE, OR A COMPUTER PROGRAM

Not applicable.

### BACKGROUND OF THE INVENTION

1. Field of the Invention

The present invention relates generally to the provision of mentally improving services to people and more specifically to the provision of cognitive reserve enhancing services and activities at a “check-in and stay”-type setting such as a destination resort spa, hotel or motel, or a complex (such as a condominium) where people live.

2. Description of Related Art

Scientists have observed that some people who are found to have significant brain damage (e.g., manifestations of Alzheimer's disease detected in post-mortem examinations) showed little damage clinically just before their deaths. That is to say, some people appear to be more resilient to brain damage than others. To explain this observation, scientists have devised the term and model “cognitive reserve,” which encompasses better brain “hardware” (e.g., brain size and number of neurons) and better brain “software” (brain processing ability-like memory, and processing speed) which allows people to avoid and more resiliently deal with brain damage (e.g., Alzheimer's' disease, dementia and stroke). With regard to better brain hardware, scientists argue that having a bigger, stronger brain makes one less likely to suffer brain damage. With regard to better brain processing, scientists argue that being able to use existing mental networks more effectively and being able to develop alternative mental networks more efficiently makes one better able to deal with brain damage.

Since cognitive reserve was first talked about in the literature—which most people say was in 1988 in an “Annals of Neurology” report—there has been considerable interest in the topic and many studies and articles on the matter. One of those articles—by Marcus Richards, Amanda Sacker and Ian J. Deary, entitled “Lifetime Antecedents of Cognitive Reserve,” in the book Cognitive Reserve: Theory and Applications, edited by Yaakov Stern, Taylor & Francis, 2007, identifies a number of factors which can contribute to pre-morbid cognitive ability—including brain size and function (neural network density and complexity and processing capacity and efficiency) and “influencing factors” (such a genes, early social and material environment, education and occupational attainment, physical health and health behavior and lifestyle). Richards et al. specifically note that factors associated with cognitive benefit during maturity include physical activity, nutrition and social and intellectual engagement Richards et al. conclude that cognitive reserve reflects the combined influence of factors (such as the aforementioned factors) and that cognitive reserve can be modified at all stages of the life course and that cognitive function in later life can be improved. Virtally all scientists are in accord with these comments and that article is incorporated herein by this reference thereto. For example, in Yaakov Ster's “The Concept of Cognitive Reserve: A Catalyst for Research,” also in Cognitive Reserve: Theory and Applications, Yaakov Stem notes that a consistent set of variables have been linked with the concept of cognitive reserve, including IQ, educational and occupational attainment, and enriching activities; that cognitive reserve is a malleable entity; that cognitive reserve can be enhanced and that people's ability to maintain their capabilities in the face of insult to brain function can be improved. That article is also incorporated herein by this reference thereto.

Notwithstanding the considerable discussion of cognitive reserve in technical literature, there are virtually no patents on the subject.

U.S. patent application 20060019227, entitled “Methods for Cognitive Treatment,” notes that “[m]ental energy is dependent upon physical exercise, rest, control of stress factors, genetic makeup and good nutrition” but is concerned only about maximizing ability to perform tasks described in modules for enhancing short-term, active working and long-term memory. It does not teach providing the items claimed herein. No known organizations have noted that nutrition, physical exercise and mental exercise are good about enhancing cognitive ability, and therefore provide—or teach unified providing by a business entity—the various elements they say are good. As the present document recognizes, certain business organizations—such as destination resort spas, check-in health centers and the like—actually provide items (like food and opportunities for exercise) to people. Other patents besides U.S. patent application 20060019227 exist but rather than claim the provision of physical, mental and nutrition items—as does the present patent application—they focus on use of drugs and computer programs to enhance cognitive ability. Business entities like destination resort spas, check-in health centers and the like own no relevant patents.

Cognitive research has application to normal people, as well as to people who have suffered brain loss caused by aging (e.g., dementia), as well as to people who have suffered brain loss caused by traumatic brain injury (e.g., stroke). Furthermore, cognitive reserve relates to HIV/AIDS as evidenced by Matthew J. Reinhard, Paul Satz, Ola Selnes, Ned Sacktor, Bruce Cohen, James Becker and Eric Miller's article “Brain Reserve: HIV Morbidity and Mortality,” in Cognitive Reserve: Theory and Applications, edited by Yaakov Stem, Taylor & Francis, 2007 (which is incorporated herein by this reference thereto). The present application offers a treatment for HIV/AIDS which the PTO recognizes as important (see MPEP 708.02, X) and for which a petition to make special should be granted.

It is well settled that cognitive reserve can be measured clinically. Thus, when one engages in cognitive reserve enhancing activities and thereby enhances his or her cognitive reserve, a concrete and tangible result (i.e., an indication of a higher cognitive reserve) can be obtained. Having a higher cognitive reserve is unquestionably useful, as it makes one more resistant to loss of mental capacity. Since the subject matter process of this patent produces a concrete, useful and tangible result, it is patentable per the USPTO's guidelines for patent examiners to determine if a given claimed invention meets statutory requirements.

It is also well settled that U.S. patents can properly be issued for business methods of assisting people. For an example of this, please see U.S. Pat. No. 7,211,054, entitled “Method of treating a patient with a neurodegenerative disease using ultrasound,” assigned to the University of Rochester.

At the same time that people are becoming increasing convinced that they can think better, business entities such as destination resorts, hotels and spas offer their clients a multitude of services to make them feel better physically, but not to think better or be better mentally. For example, according to the publication “2007 Leading Spas” (a copy of which is attached) business entities such as spas offer “spa treatments” such as aromatherapy, beauty treatments, body treatments, ayurvedic treatments, hot stone treatments, facials, massage, nail care and reiki and that yoga massage and “exercise disciplines” such as aquatics, low-impact aerobics, muscle toning, outdoor cycling and walking, pilates, spinning, stability ball, step, stretching, tai chi and yoga According to the 2007 Leading Spas publication, leading spas include packages that “nourish” the mind and “invigorate” the mind; but they do not talk about or offer any nutrients, physical exercises or mental exercises designed to do exactly that. Business entities such as spas offer no treatments or disciplines focused on enhancing the cognitive reserve of its clients, guests or customers. U.S. Pat. No. 6,753,302 betrays the present focus of spas: whipped cocoa baths. The instant invention is concerned with making people think better and be more resilent to brain disease, not to dip them in chocolate.

It does not make good sense for business entities to offer its clients many options for a better body and longer life, but to offer its clients no options to have a better mind and more fulsome life. It is a shortcoming and deficiency of the prior art that business entities like destination resorts do not include cognitive enhancing treatments or disciplines among their offerings.

### BRIEF SUMMARY OF THE INVENTION

The shortcoming and deficiency of the prior art is addressed by the method of doing business including the provision of menu choices identified as enhancing cognitive reserve, the provision of physical activities to enhance cognitive reserve and the provision of mental activities to enhance cognitive reserve.

The shortcoming and deficiency of the prior art is also addressed by the method of assessing the cognitive reserve of a person, by suggesting activities to that person so they can enhance their cognitive reserve and providing activities to people to allow them to enhance their cognitive reserves. The activities that can be provided may be eating activities, physical activities (to develop brain “hardware”) and mental activities (to develop brain “software”).

Still further, the shortcoming and deficiency of the prior art is addressed by business entities advising people about cognitive reserve, advising people how to increase their cognitive reserves and providing activities to people that allow them to increase their cognitive reserves. The activities that can be provided include eating activities and physical/mental activities (for increased brain size/better mental processing).

### BRIEF DESCRIPTION OF THE SEVERAL VIEWS OF THE DRAWINGS

The objects, features and advantages of the present invention will become better understood with regard to the following description and drawings wherein:

FIG. 1 is a block diagram illustrating steps in one embodiment of the present invention;

FIG. 2 is a block diagram illustrating steps in a second embodiment of the present invention; and

FIG. 3 is a block diagram illustrating steps in third embodiment of the present invention.

### DETAILED DESCRIPTION OF THE INVENTION

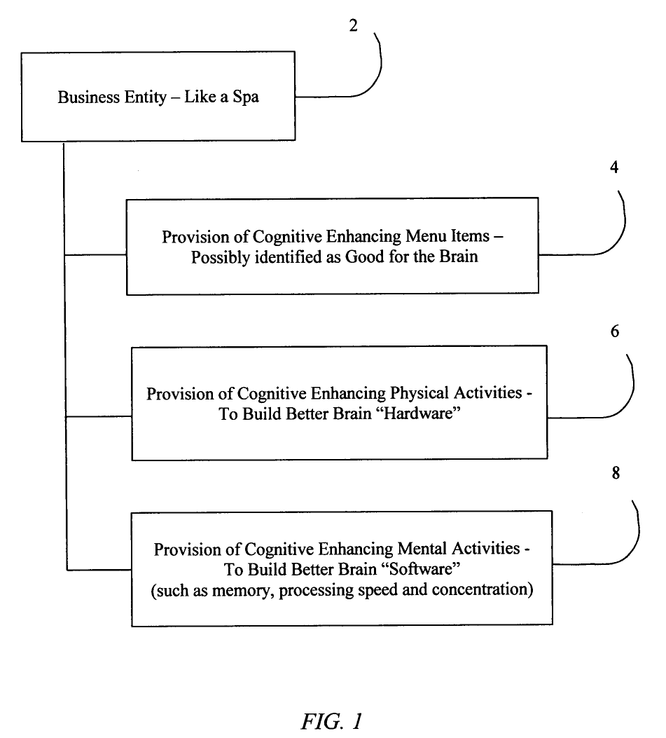

Referring now to the drawings wherein like or similar elements are depicted with identical reference numerals throughout the several views and, more particularly, to FIG. 1, there is shown an embodiment of the present invention including element 2, which stands for a business entity. No known business entity, such as a spa or check-in health center, provides cognitively enhancing menu items 4, cognitively enhancing physical activities (to build better brain hardware) 6 and cognitively enhancing mental activities (to build better brain software) 8 to its clients, customers or guests.

With regard to element 4, nutrition is identified throughout the literature as key to brain development. An example of this may be seen in Chapter 5 (entitled “Nutrition: The Key to Normal Brain Development”) by Stephen Cunnane in his book Survival of the Fattest: The Key to Human Brain Evolution, World Scientific, 2005. In Chapter 8 of that book, Dr. Cunnane identifies docosahensaenoic acid (DHA) as the brain's selective (“selective” meaning that this substance—even though used by the body outside the brain—is needed for large brain evolution and normal human brain development. A “selective” acid or nutrient or the like, according to this usage, is needed by the brain moreso than something that is merely “important.”) fatty acid. In Chapter 6 Dr. Cunnane identifies iodine as the primary brain selective nutrient. In Chapter 7 Dr. Cunnane identifies iron, copper, zinc and selenium as the other brain selective minerals. Virtually all sources of information about good nutrition for the brain—good “food for thought”—are in accord with Dr. Cunnane's observations. According to the instant invention, a business entity would include DHA and iodine rich foods on its menu, and it could identify to people ordering food off that menu that the DHA and iodine-rich foods—or other “brain foods”—are good for the eater's brain. Copies of chapters 5, 6, 7 and 8 of Dr. Cunnane's book are included herein for the examiner's reference. Further, please note that the instant application hereby incorporates by reference those chapters by this reference thereto.

With regard to element 6, physical activity has been shown to be inversely associated with cognitive decline in older people. That is to say, physically active people cognitively decline less. Information about this can be found in Miranda Dik, Dorly Deeg, Marjolein Visser and Cees Jonker's article “Association between early life physical activity and late-life cognition: Evidence for cognitive reserve,” in Cognitive Reserve: Theory and Applications, Taylor & Francis, 2007. Further, many trials have found improvements in cognitive function with physical fitness training. There is evidence that aerobically trained individuals have outperformed non-aerobically trained subjects on a variety of cognitive tasks. For further information about the last two points, please see Brent Small, Tiffany Hughes, David Hultsch and Roger Dixon's article, “Lifestyle activities and late-life changes in cognitive performance,” in Cognitive Reserve: Theory and Applications, Taylor & Francis, 2007. Like Dr. Cunnane's chapters, the Dik et al. article and the Small et al. article are hereby incorporated herein by this reference thereto.

With regard to element 8, memory and processing time are good phenotypes by which cognitive reserve is indicated. In the literature a number of ways in which cognitive reserve may be mentally enhanced are specified—such as by reading, writing and playing board games, cards, puzzles, word games, mind teasers and the like. Information about these two points may be found in Joseph Lee's article “Understanding cognitive reserve though genetics and genetic epidemiology,” in Cognitive Reserve: Theory and Applications, Taylor & Francis, 2007, and in Robert Wilson, Lisa Barnes and David Bennett's article “Assessment of lifetime participation in cognitively stimulating activities,” in Cognitive Reserve: Theory and Applications, Taylor & Francis, 2007. Both the Lee article and the Wilson et al. article are incorporated herein by this reference thereto.

Further information about exactly how steps 4, 6 and 8 may be practiced in embodiments of the present invention follow.

### (With Regard to Step 4) Diet

Much of the information about your brain is not controversial. Based upon CAT scans, MRI scans, imaging studies—a wealth of techniques for getting information about the brain—we know and can learn quite a bit about it.

However, there is one thing that is controversial: how your brain came about. Some people—creationists—hold that it just appeared as is. Other people—evolutionists—hold that it developed from predecessor brains. When you ask an evolutionist what predecessor brains modern brains (Homo sapiens brains) evolved from you learn that they are not sure. At the moment, however, taking the evolutionist viewpoint, there are three generally accepted homo species preceding Homo sapiens (who has existed about 100,000 years, although some authorities claim that “he” has existed for about 300,000 years): Homo habilis (who existed from about 2.4 million years ago to about 1.5 million years ago), Homo erectus (who existed from about 1.8 million years ago to about 70,000 years ago) and Homo neanderthalensis (who existed from about 250,000 years ago to about 30,000 years ago). We can call the progression from Homo habalis through Homo erectus and Homo neanderthalensis to Homo sapiens the chain of four. Scientists have constructed this chain by examining genetic evidence. Cro-Magnon men were really the first humans. Some “species” that you may have learned about—like “Java man”—are no longer considered to be separate from the aforementioned chain. All homo species are bipedal (that is, they walk on two legs, which freed up their hands to make tools), have relatively large brains (compared to “other” primates—who are genetically close to man but are significantly different from them), have modestly sized jaws and opposable thumbs.

Modern man's first ancestors—Homo habalis “people”—were about 4 feet tall and weighed about 100 pounds. Their brains occupied about 600 cubic centimeters.

Modern man (Homo sapiens, or “wise man”) has a brain that occupies between 1000 and 1850 cubic centimeters.

This raises the question—which has been raised elsewhere—what kind of diet caused or supported the growth of the human brain from about 600 cubic centimeters to about 1450 cubic centimeters. Stated another way, what kind of diet allowed our brains to double or triple in size?

Scientists usually point to things like the rise of language and tool making to explain the massive expansion of early humanoid brains. In that case, a brain diet supported the new large brain. Other scientists argue that the fact people became more capable did not cause their brains to expand, rather, the fact that people's brains expanded enabled them to do more things (like communicate more, and use tools)—something had to start the process of brain expansion and what that thing was what they ate. In that case, a brain diet caused a new large brain to form.

Notwithstanding whether the chicken (increased ability) or the egg (a much larger brain) came first, it is clear that our brains did at least double in size in our earliest days—or perhaps our brains originated from nothing—and there is a diet that can support, if not cause, a relatively speaking huge brain. Additionally, scientists add, if diet can cause our teeth to change (like large flat teeth suggesting chewing of plant material and large pointed canines suggesting meat consumption), diet can also certainly cause our brains to change. Therefore, there must be a good “brain dief” (which our ancestor, Homo habalis, had).

If you accept that our brains evolved, you can see two important lessons in the process of their development.

First, even though life has extended for as long as you can remember—and therefore for a very long time—the fact of the matter is that Homo sapiens (modern man) has not lived long. In the chain of predecessors to Homo sapiens is Homo erectus. Homo erectus appears to have lasted for over a million years without a substantial change in physique. Humans per se have lasted a much shorter period of time than a million years—about 100,000 years. Furthermore, we are constantly at risk of destroying ourselves, as by warfare and pollution—whatever creativity and technological potential we may has been and can increasingly be limited by carelessness and aggression. Relatively speaking, “we” have not lived nearly as long as creatures like us, and if we are not careful, we can cause ourselves to go away.

Second, we cannot count on our “intelligence” to bail us out. In the chain of species between Homo habalis and Homo sapiens is Homo neanderthalensis (Neanderthal man). Neanderthal man lived during the last ice age and became extinct about 30,000 years ago. Neanderthal man, like Homo erectus, existed longer than modern man (according to most authorities). Neanderthal man is widely accepted to have had a larger brain than modern man (about 10% larger). Whether or not Neanderthal man was smarter than modern man is a good question, but some people are quick to say that he was, but being smart wasn't advantageous evolutionarily, kind of like the smartest kid in high school probably didn't attract all the women. So, arguably, smarter “people” than us, known to be stronger (more brawny) than us, who lived longer than us, have not survived as a species. We should not think that we are immune to a similar fate. Doing what we can to help other people—and not focusing on being as smart as we can be—appears to be key to our survival.

With regard to nutrition, it seems more than fair that if your brain can make 100 trillion decisions a second that are good for you (which authorities generally accept), you should make a dozen or so decisions a day (about what to eat and drink) that are good for your brain.

Viewed another way, it is clear that there are a number of substances—that could be combined into designer supplements—that can dramatically increase the health of the body and brain and vascular systems.

Scientists have conducted studies to better understand how changes in particular nutrients alter the brain, thereby affecting intelligence, mood and the way people act. Scientists are quick to say that there are five reasons why it is difficult for them to reach any definitive conclusions. First, nutrition never exists alone. Factors other than nutrition can affect behavior. Thus, if nutrition changes, and behavior changes, there may be a link, or there may not be a link. Non-nutritional inputs—like from school, society and family—can cause behavioral changes too. Second, it is difficult to alter only one substance in the human diet. Therefore, it is difficult to determine if a particular substance has a certain effect on the brain. Most scientists would consider it unethical to eliminate a particular nutrient from the human diet to see what happens. In such cases, the scientists either conduct animal experiments, or they see what happens to people in the cases of famines, or they forego doing experiments: all of which “approaches” are less than 100% helpful. Third, different people respond to different diets in different ways. Just because someone needs and responds to a particular nutrient some way does not mean that you will need and respond to the nutrient similarly. Fourth, a change in diet can have a placebo effect. If a person thinks that a particular nutrient will positively affect his or her behavior, it may positively affect his or her behavior, even through it is really doing nothing. Finally, definitions are never settled. It is hard to say what better behavior is. It is hard to say what a better mood is. It is hard to say what intelligence is (and many people think that IQ tests don't accurately measure intelligence).

Notwithstanding the “difficulties”—set forth above—you still wonder: what nutrient plan should I adopt to do good for my brain. And you don't to hear: it is hard to say.

### BACKGROUND

People consistently note that while we used to rely on strong muscles for a good life, today we rely on a strong mind. In the ongoing “information age,” having a strong brain is critical to understand and deal with the world.

People also consistently note that the brain uses a lot of blood, oxygen and glucose (reportedly 20%, 25% and 25%). Thus, any shortage of nutrients in the body has strong negative impact on the brain. The fact that the brain consumes much of our energy also makes it extremely sensitive. Just like cutting off blood to the brain for ten seconds likely results in unconsciousness, a nutritional deficiency will have a fast, negative impact on the brain.

Many people think that common brain problems—like forgetting things (the alleged “senior moment”) and “mental fogginess”—are caused by cellular damage incurred by free radicals [an especially reactive atom or group of atoms that has one or more unpaired electrons, produced by the body or introduced from an outside source (as tobacco smoke, toxins or pollutants) and that damage cells, proteins and DNA by altering their chemical structure]. These people also think that antioxidants “neutralize” free radicals—which, at a minimum, prevents further cell or tissue damage. More than just preventing damage, however, some studies have found that people who consume high levels of antioxidants have a mental function eight to ten years younger as compared to their peers who consume few antioxidants. Such studies support the idea that antioxidants can improve the brain, not just keeping it from getting worse.

In the literature you can find nutritional recommendations if you want to think better. You can also find—and the recommendations are a little more strenuous—nutritional recommendations if you want to prevent a brain disease. You can also find—most strenuous of all—nutritional recommendations for recovery from brain disease. In summary, what follows is a compilation of the latter recommendations.

What Nutrients Should be Included in a Diet to Recover from the Effects of Brain Disease

### 1. Docosahexaenoic Acid (DHA) (an Omega-3 Essential Fatty Acid)

A. Why it is good: About 60% of your brain is formed of essential fatty acids—good fat. Essential fatty acids make your brain cell membranes flexible, better able to communicate with other brain cells (so you can think quicker and better!). If there are not enough essential fatty acids on hand to make new brain cells, and to repair old ones, the brain uses bad fats (like trans-fats), which make relatively rigid brain cell membranes. Brain cells with bad fat constructed (rigid) membranes don't communicate as well as brain cells with essential fatty acid constructed (flexible) membranes. For this reason, some physicians will say “sluggish fat produces a sluggish brain, and good fat produces a good brain.”
B. Where can you get them: Fatty fish (like salmon, tuna and sardines) is an excellent source of these fats. However, most people do not eat enough fatty fish to obtain sufficient essential fatty acids in their diets, making taking supplements advisable.
Omega-3 supplements often contain both docosahexanoic acid (DHA) and eicosatetraenoic acid (EPA) (shown in the chart on page 154 of Chapter 8 of Stephen Cunnane's book, which has been incorporated herein). Many scientists think that DHA and EPA are good for brain health. It would be smart to take an Omega-3 supplement to get both those nutrients.
What is a good recommended dose: 600 mg daily

### 2. Antioxidants (Vitamin E and Vitamin C) and Ginseng, Kava Kava, Royal Jelly, Gotu Kola and Rosemary

A. Why they are good: Notwithstanding the fact that some researchers have found that taking Vitamin E supplements increases the chance of you having a hemorrhagic stroke (which constitutes about 1 out of 5 strokes), most researchers think Vitamin E is a “smart pill.” Researchers at the Chicago Health and Aging Project have reported that people who consume high levels of vitamin E are eight to ten years smarter than their counterparts who consume little vitamin E. Thus, many people think that taking vitamin E supplements can enable you to gain a decade's worth of brain power. Vitamin E is often considered to be the antioxidant (elements that promote youth by fighting free radicals) that is most important to your brain because it is fat soluble and, as the brain is about 60% fat, vitamin E is prevalent in your brain, protecting it from attack by free radicals. Vitamin C has a similar structure to glucose, the brain's sugar fuel. Because it is much like glucose, vitamin C shows up in large concentrations in the brain. Not only does vitamin C offer its own antioxidant protection, it is reported to boost the effectiveness of vitamin E. Because vitamin C and vitamin E are known to work hand in hand, research studies often administer both of them together. Studies reveal that ginseng allows people to work longer and harder at mental tasks (which may appeal to you!). Kava kava, both a plant and a beverage made from it) is said to elevate mood and relieve stress. Royal jelly, which is the sole food of the queen bee, is a rich source of B-vitamins and essential fatty acids. Gotu kola, from a creeping marsh plant, which is used in India much like the Chinese use ginseng, is said to improve circulation to the brain, improving learning and memory. Although gotu kola is sometimes confused with kola nut (which contains a lot of caffeine), gota kola contains no caffeine, and it often used by people who are interested in boosting their energy without consuming caffeine. Rosemary, the “dew of the sea,” considered by ancient Egyptians, Hebrews, Greeks and Romans to be sacred, has been used for centuries to enhance memory.
B. Where you can get them: Coffee is the number one source of antioxidants in the American diet—and nothing else even comes close—according to a report delivered to the American Chemical Society back in 2005. Besides coffee, fruits and vegetables are good sources of antioxidants. Vitamin E and vitamin C exist in high concentrations in the brain. You can opt to take a vitamin E and/or vitamin C supplement(s). Likewise, you can opt to take ginseng, kava kava, royal jelly, gotu kola and rosemary (oil) supplements.
C. What is a good recommended dose:
   1. Vitamin E: 400 IU daily
   2. Vitamin C: 400 mg daily
   3. Ginseng: 400 mg daily
   4. Kava kava: 30% extract, 300 mg daily
   5. Royal jelly: 500 mg daily
   6. Gotu kola: 400 mg daily
   7. Rosemary (oil): 30 ml, one drop on each temple daily

### 3. Minerals

A. Why they are good: Minerals—including iodine, iron, copper, zinc, selenium, potassium, chromium, boron, manganese, and molybdenum—are reported to provide key ingredients for neurotransmission—your brain's communication with your body.
One mineral that has attracted a lot of attention in the area of brain science is iodine. Iodine is known to be commonly present in marine foods. Iodine forms thyroid hormones. Thyroid hormones play a basic role in biology—regulating the basal metabolic rate.
The United States Food and Drug Administration (the FDA) recommends that everyone consume 150 micrograms of iodine per day. The FDA considers iodine necessary for proper production of thyroid hormones. Natural sources of iodine include sea life, such as kelp and certain seafood, as well as plants grown in iodine-rich soil. Salt for human consumption is often enriched with iodine and is referred to as iodized salt.
In areas where there is little iodine in the diet—such as remote inland areas where no marine foods are eaten—iodine deficiency gives rise to a thyroid problem, which can cause extreme fatigue, mental slowing and depression.
Summing all this up, iodine is known to be an essential “brain food”—it is important that iodine be part of a cognitive reserve enhancing diet.
Iron increases oxygen uptake in the brain, which increases people's cognitive ability. People who are iron deficient—“anemic”—are known to have increased fatigue, weakness and headache. Dietary iron deficiency is known to reduce neurotransmitter levels.
Copper is essential for protection of part of the brain, additional capacity (and increased blood flow) for energy production for the brain and support for generation of brain signals.
Zinc is needed for the normal activity of over one hundred enzymes. Zinc is essential for normal growth, development, reproduction, taste, appetite and tissue repair. Zinc deficient animals are known to have impaired learning and memory.
Selenium is essential for the brain to obtain oxygen and ramp up energy metabolism. Selenium plays a key role in iodine metabolism which, in and of itself, makes it an important brain nutrient.
Potassium helps maintain fluid and electrolyte balance in the body. Potassium also allows muscle contraction and the sending of nerve impulses. Americans are widely thought to consume only half the amount of potassium they need each day.
Chromium is required in trace amounts for sugar metabolism in humans. However useful one may find chromium, one should be careful. Hexavalent chromium is very toxic when inhaled as popularized by the movie Erin Brochovich. Recently it was shown that the dietary supplement chromium picolinate complex causes chromosome damage in hamster cells.
Boron in very tiny quantities is known to be necessary for the optimal health of animals.
Manganese (II) ions function as cofactors (a non-protein chemical compound that is tightly bound to an enzyme and is required for catalysis) for a number of enzymes and is thus a required trace element for all known living organisms.
Molybdenum assists with growth, appetite and reproduction.
B. Where you can get them: Dairy foods, leafy green vegetables, nuts, tomatoes, bananas, table salt, meat, eggs, legumes (peas and beans) and enriched (iron-containing) grains Much research holds that humans often benefit from mineral supplementation. Vitamins and minerals are interdependent, requiring the presence of others for full benefit; thus, taking a multivitamin without minerals is not nearly as effective as taking one with minerals.
C. What is a good recommended dose: As provided by a One-A-Day multivitamin/mineral supplement and/or other mineral supplements (including at least 150 mg of iodine a day as well as copper, zinc, iron and selenium).

### 4. B-Vitamins (B1, B3, B6, Folic Acid, B12), Choline, Tyrosine and Tryptophan

A. Why they are good: Scientists say that B vitamins are critical for brain health because they lower the level of homocysteine—an amino acid found naturally in the body—that is reported to reduce blood flow to the brain and kill brain cells. Researchers have found a clear link between elevated homocysteine and decreased mental performance. Elevated homocysteine has been found to show reaction times.
B. Where you can get them: Although B vitamins exist throughout our food supply—showing up in meat, fish, eggs, whole grains and fortified cereals—they are frequently lost before they are consumed. B vitamins are fragile. They are destroyed by microwave cooking and high heat. B vitamins are also water soluble. They are often absorbed into cooking fluids and lost. Vitamin B1 is destroyed by alcohol; alcoholics are often deficient in this nutrient. Since animal products are a significant source of many B vitamins, vegetarians are at risk of running low on them, especially vitamin B12. All in all, the best source for B-vitamins is a supplement. Choline is a chemical precursor or “building block” needed to produce the neurotransmitter acetylcholine, and research suggests that memory, intelligence and mood are mediated at least in part by acetylcholine metabolism in the brain. Although there is debate about the whether it is good or bad to have choline in your diet, many people think it is good. The Food and Drug Administration (FDA) requires that infant formula be made from cow's milk containing choline. Choline reportedly enhances memory and revitalizes your brain so you feel more energetic. Tyrosine, from the Greek word “tyros,” meaning cheese, where it was first discovered in 1846, has not been studied much. Tyrosine reportedly improves mental alertness and quick response, eases anxiety and helps to relieve tension. Tryptophan makes you feel more relaxed. Typtophan reportedly helps your thinking stay clearer and eases the effects of stress. Typtophan was banned in the U.S. for most of the 1990's because a source of it was linked to a disabling, sometimes deadly, autoimmune disease. According to a popular belief, eating tryptophan in turkey meat causes drowsiness.
C. What is a Good Recommended Dose:

| | |
|---|---|
| 1. One B-complex supplement daily including: | |
| 1. B1: | 50 mg |
| 2. B3: | 50 mg |
| 3. B6: | 50 mg |
| 4. Folic acid: | 400 mcg |
| 5. B12: | 500 mcg |
| 2. Choline: | 425 mg |
| 3. Tyrosine: | 500 mg |
| 4. Tryptophan: | 500 mg |

### 5. Calcium and Magnesium

A. Why they are good: Calcium has been found to boost the potential of nerve and muscle cells so they communicate better. Magnesium is reported to increase cell energy and help produce neurotransmitters.
B. Where you can get them: For calcium: milk, cheese and yogurt. For magnesium: pumpkin and squash seeds, nuts (brazil nuts, almonds and cashews) and bran cereal.
C. What is a good recommended dose:

| | |
|---|---|
| 1. Calcium: | 1200 mg daily |
| 2. Magnesium: | 400 mg daily |

### 6. Co-Q10

A. Why it is good: Although Co-Q10 is common (sometimes called the “spark plug” that generates energy within each cell in your body), especially in your metabolically active brain, your body produces less and less Co-Q10 as you age. There is a strong belief in the scientific community that low levels of Co-Q10 cause mental decline as you age. Scientists argue that if you can't think, learn or remember things, it is because you don't have enough Co-Q10 to power your brain.
B. Where you can get it: Beef, pork and eggs. There are plenty of vegetable sources of Co-Q10, the richest currently known being spinach, broccoli, peanuts, wheat germ and whole grains—in that order—although the amount of Co-Q10 found in vegetables is significantly smaller than that found in meat.
C. What is a good recommended dose: 200 mg daily

### 7. Alpha Lipoic Acid (Lipoic Acid)

A. Why it is good: Alpha Lipoic Acid, administered in concert with Acetyl-L-carnitive, has been found to enhance memory function without damaging brain cells. This is not a minor accomplishment, as drugs that are strong enough to alter brain chemistry often kill brain cells.
B. Where you can get it: Lipoic acid is found in a variety of foods, notably kidney, heart and liver meats as well as spinach, broccoli and potatoes.
C. What is a good recommended dose: 200 mg daily

### 8. N-acetyl-cysteine (NAC)

A. Why it is good: N-Acetyl-Cysteine (NAC), taken orally, raises blood levels of glutathione. Glutathione production declines with age; NAC boosts glutathione. Glutathione has been shown to boost immune system function. Some researchers report that glutathione is designed to protect the brain and nervous system. NAC has powerful antioxidant effects. In addition to protecting the body from oxidative damage resulting from metabolic and environmental toxins, NAC has shown positive effects on liver function, protecting the liver from heavy metals like lead and mercury.
B. Where you can get it: NAC is found in a variety of protein sources including ricotta cheese, cottage cheese, yogurt, port, red meat, poultry, wheat germ, granola and oat flakes.
C. What is a good recommended dose: 800 mg daily

### 9. Acetyl-L-carnitine

A. Why it is good: Acetyl-L-carnitine, which is the chemically active form of the amino acid carnitine, is naturally produced by the body and found in food. Carnatine plays important roles in generation of brain energy. People with Alzheimer's disease have been found to have markedly low levels of carnitine. Thus, often people with Alzheimer's disease are given Acetyl-L-carnitive supplements to counter the degenerative effects of that disease.
B. Where you can get it: Meat, poultry, fish and dairy products are the richest sources of acetyl-L-carnitine, while fruits, vegetables and grains contain relatively little acetyl-L-carnitine.
C. What is a good recommended dose: 800 mg daily

### 10. Phosphatidylserine

A. Why it is good: Phosphatidylserine (PS), a fatlike substance concentrated in brain cell membranes, is held by some people to improve the memory of memory impaired people.
B. Where you can get it: Supplements. There is a cloud on phosphatidylserine (PS) supplements. Historically they was made with cows brains. Today, because of concerns that cow brain supplements might spread diseases, PS supplements are made with soy. Some people think that the new soy-derived PS supplements are ineffective.
C. What is a good recommended dose: 200 mg daily

### 11. Ginkgo Biloba

A. Why it is good: Many studies have confirmed that ginkgo biloba improves blood flow to the brain and enhances mental function and memory. There is study reported in the Journal of American Medical Association (JAMA) where about 30% of the people, including stroke survivors, who took a daily dose of ginkgo extract showed improvements on tests of reasoning, memory and behavior.
B. Where you can get it: Supplements—pretty much exclusively. Many people think that taking ginkgo biloba supplements is a good idea. Ginkgo biloba is safe. Ginkgo biloba has been used by physicians in Europe for decades to enhance brain function. Also, it has been used by healers in China for thousands of years.
C. What is a good recommended dose: 360 mg

### 12. Vitamin D

A. Why it is good: Vitamin D reportedly helps you improve your mood. Vitamin has been shown to improve the mood of people who suffered from seasonal affective disorder (SAD)—that is, people who feel sad during periods when they are exposed to less sunlight Sunlight is thought to trigger the production of seratonin, a chemical in the brain, that controls mood. In addition to its mood-enhancing properties, vitamin D is a strong antioxidant, and it protects brain cells from free radical attacks, which some researchers think causes mental performance problems.
B. Where you can get it: Milk, a fortified rice or soy beverage, canned salmon and canned tuna.
C. What is a good recommended dose: 400 IU daily

### 13. Vinpocetine

A. Why it is good: Vinpocetine has been found to increase blood flow to the brain.
B. Where you can get it: Supplements. For more than two decades vinpocetine has been used in Europe and in Japan to treat stroke survivors having reduced blood circulation. Vinpocetine became available over the counter in the United States in the late 1990's. Vinpocetine's ability to increase blood flow can cause a severe problem for people on some form of blood thinner (such as Coumadin or Plavix). Because vinpocentine can cause problems for people on blood thinners, and many stroke survivors are put on blood thinners by their physicians, vinpocetine is little used.
C. What is a good recommended dose: 10 mg

I am sure that people will add other “nutrients” to this list. In May 2007 physicians in Detroit began studying whether Viagra can help stroke survivors. Before this human test, animal tests had shown that Viagra—used by millions of men to improve their sexual performance—can improve memory and movement by helping injured brains develop new cells and blood vessels. Despite the ancient Chinese curse—“may you live in interesting times”—we do live in interesting times, and the promise of a future with even more options to recover from a brain disease is an exciting one.

### What is the Best “Brain Diet”—the Best “Food for Thought?”

Since you are endeavoring to give your brain every possible nutrient it may need, it makes good sense to ensure that you consume every single nutrient recommended by anyone, unless you know that taking some particular “recommended” nutrient does not make sense for you (like if you are on a blood thinner, you certainly wouldn't want to take vinpocetine). To be safe and certain, if you do decide to take supplements to ensure that you have sufficient of the recommended nutrients in your body, you should talk about that matter with your physician, and obtain his or her approval.

With regard to your general diet:

It is good to eat more fruits and vegetables. Scientists have concluded that people who eat five or six servings of fruits and vegetables a day have a 31% lower risk of ischemic stroke compared to people who eat less than three servings a day. The best foods: green leafy vegetables (like spinach), citrus fruits (like oranges) and cruciferous vegetables (like broccoli and cauliflower). Potatoes and most beans (like chickpeas and pintos) offer no detectable protection. Increased number of fruits and vegetables have also been shown to lower blood pressure—or to keep it from rising—as effectively as drugs. High blood pressure is known to cause a number of medical problems for people.

It is good to eat seafood. Scientists have found that people who eat seafood two to four times a week have about half the risk of ischemic stroke compared to those who eat it less than once a month.

It is good to eat low sodium and low cholesterol foods. Studies have shown that limiting sodium, saturated fat and cholesterol have positive effects on your blood pressure.

It is good to eat more whole grains and high-fiber food, and less refined and low-fiber food. This will increase your store of slowly burned carbohydrates, which are an excellent source of food energy that your brain craves.

It is a good idea to take a multivitamin/multimineral supplement. This will ensure that you get all your B-vitamins (which lower a particular amino acid in your blood and, thus, we understand, reduces the risk of stroke), most antioxidants, most (if not all) minerals, calcium and magnesium.

It is a good idea to take an essential fatty acid supplement. Your brain needs DHA and a lot of it.

It is a good idea to take other supplements, especially if you think your diet may be deficient in certain areas. For example, if you don't eat a lot of meat and eggs you should take a Co-Q10 supplement. If you don't eat a lot of organ meats or spinach, broccoli and potatoes you should take a lipoic acid supplement You may want to take a NAC supplement. You may be interested to try a PS supplement. You will likely be interested in taking a ginkgo biloba supplement. You may want to take a vitamin D supplement. If you are not on a blood thinner, and you suspect that blood flow in your brain is reduced, taking a vicpocetine supplement may make sense to you.

It would be amiss of me not to mention that there are some aspects of a diet that can have a positive effect on you, or that can have a negative effect on you. One of those things is antioxidant supplements. Some studies suggest that high doses of antioxidants, especially vitamin E, can prevent brain disease. To the contrary, a large study recently found that 50 IU a day of vitamin E raises the risk of certain types of brain disease. According to some researchers, the evidence on antioxidants is a “mixed bag.” Another possible aspect of your diet that can be either good, or bad, is alcohol. Whereas light use of alcohol (like one drink a day) is associated with a reduced risk of some types of brain disease, alcohol use of any kind brings with it an increased risk of other types of brain disease. Most physicians presently hold that if you don't already drink, you shouldn't start. Finally, foods containing low levels of saturated fat have been found to decrease your chances of having some types of brain disease (by, e.g., lowering “bad” cholesterol that, in turn, decreases the chances of having an ischemic stroke) and to increase your changes of having at least one type of hemorrhagic stroke. Since ischemic strokes are much more common than hemorrhagic strokes (about four times more common), the best policy is to do the best you can to lower your chances of an ischemic stroke by lowering—not raising—your intake of high saturated fat foods.

Nutrition plays a major role in enhancing cognitive reserve. By giving your brain what it needs to perform, you will both restore lost function and think better (sharper and faster) day in and day out.

I understand that my recommendations for the best diet for your brain may be hard to remember and apply. What would be most useful, I am sure, is a simple way to think about the topic—an easy to remember way of thinking to help you make good nutritional decisions.

A good way of looking at brain heath is to think, as a number of people have argued, that early humans primarily ate fish, shellfish and bird eggs—items that they could find on a shoreline. The thought process is this: on a planet whose surface is almost 75% water (where our land masses are crossed by rivers and streams and dotted with lakes), where life is dependent on water to survive and where our ancestors have successfully adapted for millions of years (and where, I would note, that immersion or anointing with water is a key part of the Christian sacrament of baptism), it is incomprehensible to think that people have not systematically exploited aquatic environments and habitats (like shorelines). Shorelines offered a great environment for our human ancestors to eat, settle, increase and learn. Our ancestors took to rafts, boats and flotation devices of various kinds to spread around the world: they were not afraid of the sea. Unlike many environments, shorelines offer a year round supply of food—which undoubtedly was a good thing for early people.

Like I mentioned earlier, there is a fundamental mystery and point of contention here among authorities. It is known that our brains are twice as big as our human relative, Homo habilis. Traditionally, scientists think that the rise of language and tool making sparked the dramatic growth of our brains. The contrary view is that the foods our human ancestors ate caused their brains to grow dramatically, and the bigger brains increased our linguistic and tool-making skills.

Accepting the latter theory—which is discussed in the book Survival of the Fattest, published in 2005—human brains are not only big, they are hungry. The average newborn baby's brain consumes 75% of the infant's daily energy needs. This neural demand is fed by fat. Human infants are the only primates born with excess fat. It accounts for 14% of their birth weights.

The author of Survival of the Fattest argues that baby fat fueled explosive brain growth. Shorelines provided a year-round, accessible and rich food supply. Wetlands, rivers and lake shorelines dominated east Africa's prehistoric rift valley in which early humans evolved. Early human infants were able to pack on pounds and continue to fuel the growth of their brains because their mothers were consuming a nutrient rich shoreline diet. The fittest earliest humans were those with the fattest infants—people with a shoreline diet. Shorelines provided nutrients and minerals (of which DHA and iodine are key) that fueled explosive brain growth. Then, people's brains grew dramatically because of the iodine-rich foods they were harvesting from the waters and shorelines where they lived and this explosive growth of their brains increased their language skills and ability to use tools.

A way that we get ourselves into trouble, the shoreline diet advocates argue, is when some nutrient that would be high in a fish based diet—like iodine—becomes deficient in our diets. Deficiencies in iodine lead to cognitive degeneration which companies in the 1920's sought to ameliorate by adding iodine to salt—effectively creating an artificial shore-based food item in our diets.

As time has passed we have moved away from the shore and we eat less of the type of items common to shorelines, but eating a nonshoreline diet—a nontraditional brain supporting diet—the shoreline diet advocates argue, puts our brains at risk.

Whether the shoreline theory is right or not, it can be extremely helpful for you to think about when deciding what to eat and drink.

When deciding what to drink, the best choices are water, coffee and tea. Milk is a good source of brain nutrients.

When deciding what to eat, the best choices are fish or shellfish. Non-fish possibilities for obtaining Omega-3 essential fatty acids—which your brain craves!—are not good—although Flaxseed oil is probably the best most widely available source and Omega-3 essential fatty acids can be obtained from eggs from chickens fed greens and from the meat of grass-fed animals. Ranking fish based on level of DHA the best choices are Atlantic Mackerel, then Atlantic Salmon, then Spanish Mackerel, then Chinook Salmon, then Bluefin Tuna, then Grouper, then Atlantic Herring. Regarding fresh water fish, Catfish is the best choice, then Walleye. Fish from the wild often are more nutrient rich than farm raised animals. In consuming fish, it is important to make sure that too many heavy metals—like mercury—are not consumed. Eggs are also good (like our ancestors found bird eggs at the shore). Red meat—a relatively small amount—is also good (as our ancestors ate frogs). Poultry is fine—like birds at a shoreline. Vegetarians and vegans are going to find it very hard to have a good brain diet.

It would also be hard to try to limit consumption of fat, or carbohydrates, or protein. Eskimos are known to eat lots of fat—hardly any carbohydrates—and be fine. Once minimum nutrient requirements are met, a wide range of dietary fat intake is compatible with people thriving. Additionally, as you know, your brain craves energy, which can come from slow burning carbohydrates and protein. It does not make sense to seek to limit any particular element—fat, carbohydrate or protein—to a specific amount.

It is smart to take a DHA supplement and to consume iodine rich foods (as both DHA and iodine are commonly found in shoreline foods).

It would be good to eat raw fruits and vegetables, and to eat whole grains, such as could be found around water in nature.

Any of a multitude of desserts, made with unrefined sugar for refined sugar (which can be substituted cup for cup), would be fine.

As many people have noted, the refined sugars, adulterated fats and innumerable additives in the “modern diet”—which has triggered chronic degenerative “Western” diseases—like cancer, diabetes, obesity, hypertension and atherosclerosis—are not good for your brain.

I am reluctant to say that you should not take any supplement that anyone thinks you should take. What you are trying to do—feed the most complex organ in your body so that it can operate and heal right—is too critical a goal to do anything less than 100%. To help you, what I have below is a chart listing every single substance you might want to take, together with a recommended dose, a blank for a dose you may opt to take (after reading about the substance) and a blank for your physician's approval of your plan. I suggest that you decide what supplements you want to take, in whatever dose you want (that you mark down on the attached chart) and that you get approval for your physician before you begin taking the supplements.

| | | Dose I | Approval |
|---|---|---|---|
| | | would like | of my |
| Supplement | Recommended dose | to - take | physician |
| Essential fatty acids | 600 mg daily | | |
| (DHA, and EPA: | | | |
| Omega-3 fatty acids) | | | |
| Vitamin E | 400 IU daily | | |
| Vitamin C | 400 mg daily | | |
| Ginseng | 400 mg daily | | |
| Kava kava | 30% extract, 300 mg | | |
| | daily | | |
| Royal jelly | 500 mg daily | | |
| Gotu kola | 400 mg daily | | |
| Rosemary (oil) | 30 ml, one drop on | | |
| | each temple daily | | |
| Minerals | Provided by a One-a- | | |
| | Day mineral | | |
| | supplement. It is | | |
| | especially important | | |
| | that you ingest at | | |
| | least 150 mg daily of | | |
| | iodine! | | |
| B1 | 50 mg daily | | |
| B3 | 50 mg daily | | |
| B6 | 50 mg daily | | |
| Folic acid | 400 mcg daily | | |
| B12 | 500 mcg daily | | |
| Choline | 425 mg daily | | |
| Tyrosine | 500 mg daily | | |
| Tryptophan | 500 mg daily | | |
| Calcium | 1200 mg daily | | |
| Magnesium | 400 mg daily | | |
| Lipoic acid | 200 mg daily | | |
| NAC | 800 mg daily | | |
| Acetyl-L-carnitine | 800 mg daily | | |
| Phosphatidylserine | 200 mg daily | | |
| Ginkgo biloba | 360 mg daily | | |
| Vitamin D | 400 IU daily | | |
| Vinpocetine | 10 mg daily | | |

If nutrition can help support a brain at least twice as big as whatever brain came before it, it goes without saying that nutrition can play a major role in helping your brain. Also, as some scientists have noted, if diet can affect teeth (such as making meat eaters have sharper teeth) it can also assuredly affect your brain (the most important organ you have!).

(With Regard to Step 6) Physical Activity

It is well settled that physical activity can enhance or maintain cognitive reserve during maturity. There is evidence that aerobically trained individuals outperform non-aerobically trained individuals on a variety of cognitive tasks. In one particular study, jogging was the primary physical activity used and cognitive performance was measured in terms of processing speed, memory and verbal ability. In another study, physical activity comprised number of blocks walked and stairs climbed; in that study, nearly 6000 community dwelling women aged over 65 with high levels of physical activity declined cognitively less than subjects with lower levels of physical activity. In the so-called Nurses' Health Study, including 18,766 U.S. women aged 70 to 81 years, participation in physical activities (as assessed by periodically mailed questionnaires) showed both better cognitive performance and slower cognitive decline over time. Many studies show similar associations for men. In summary, many studies have found improvement in cognitive function with physical fitness training.

In one particular large study of physical fitness training of the healthy elderly, exercise had the greatest effect for executive function (the mental capability to control and purposefully apply one's own mental skills), but all cognitive domains improved. According to the study, physical training that provided maximum benefit included combined strength and aerobic training, sessions of moderate duration (no less than 30 minutes), an overall training program of long duration (6 months or more), a higher percentage of female participants and “mid-old” participants (not younger than 65, not older than 70).

Based on the foregoing, a business entity could provide a physical workout facility where a client could begin or continue a work-out regime and, possibly, it could give its clients a work-out plan especially designed for them. Ideally, as has been shown, exercise sessions should last at least 30 minutes each, should work on both strength and aerobic fitness and should extend long term.

### (With Regard to Step 8) Mental Activity

As “brain gym” providers (people who provide computer programs designed to enable people to listen, remember and concentrate better) say, it doesn't make any sense to live a long live (by spending time at a physical fitness center as per step 6) if you don't also work to have a better brain throughout your life (by spending time at a “brain fitness center” or “brain gym”).

It is well settled that various methods and systems can be used to enhance learning skills and develop cognitive functions in people. The patents included herewith—U.S. Pat. Nos. 6,632,174, 6,261,101 and 2006/0019227—discuss many of such methods and systems in considerable detail—and the discussions in those patents are hereby incorporated herein by this reference thereto.

It would be a simple matter for a business entity—such as a spa or a check-in health center—to include a “brain gym” or “brain fitness room,” including a number of stations for use (such as the computer work station depicted in FIG. 1 of U.S. Pat. No. 6,261,101. Such a station would make it easy for a business entity to offer an opportunity for their clients to work on a cognitive reserve enhancing mental activity in software form. It is also possible for a business entity to offer opportunities for mental activities (well known in the art as well as discussed in the attached literature) to their clients that are not software based.

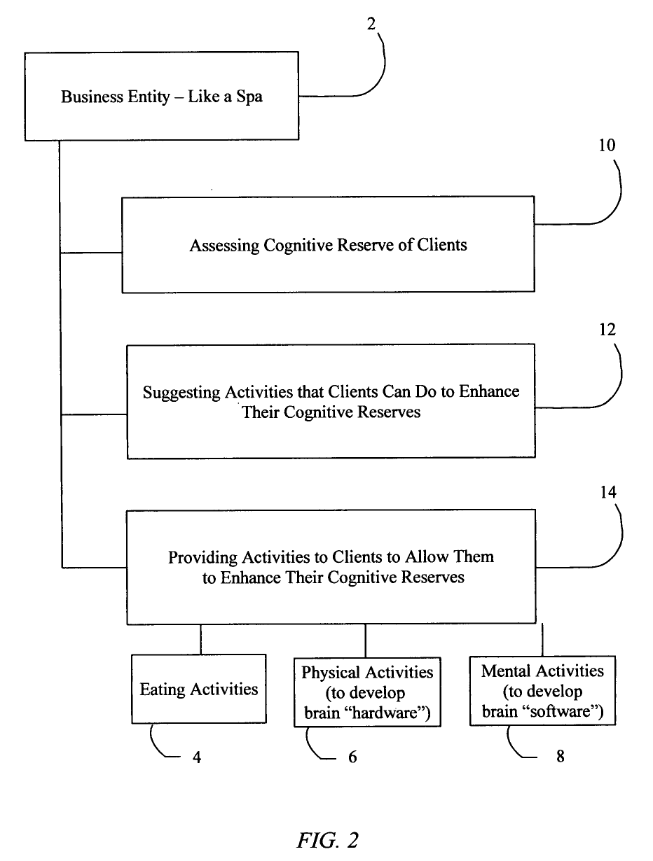

Referring now to FIG. 2, there is shown an embodiment of the present invention wherein a business entity 2 assesses cognitive reserve of a client (step 10) suggests activities that a client can do to enhance their cognitive reserve (step 12) and provides activities to clients that allow them to enhance their cognitive reserve (step 14). The provided activities are the type of activities identified and described as elements 4, 6 and 8 in FIG. 1.

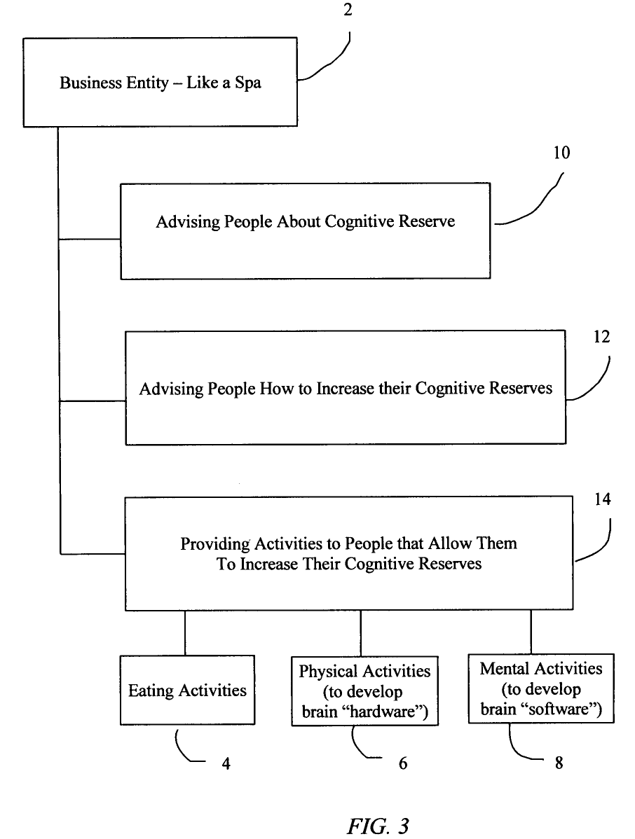

Referring now to FIG. 3, there is shown an embodiment of the present invention wherein a business entity 2 advises people about cognitive reserve (step 16), advises people about how to increase their cognitive reserves (step 18) and provides activities that allow people to increase their cognitive reserves (step 14). As in FIG. 2. step 14 in FIG. 3 can include the activities identified and described as elements 4, 6 and 8 in FIG. 1.

One possible infringer is a spa, such as a spa at a destination resort.

Another possible infringer is a hotel or motel, which provides both physical and mental workout rooms, and items on a menu advertised as “brain healthy” or the like.

Yet another possible infringer is a living complex, such as a condonium complex, which offers infringing activities as defined in the claims which follow.

Although preferred embodiments have been depicted and described in detail herein, it will be apparent to those skilled in the relevant art that various modifications, additions, substitutions and the like can be made without departing from the spirit of the invention. All modifications and variations are and should be considered to be within the scope of the invention as defined the claims which follow.

I claim:

1. A method for doing business performed by a business entity where people stay to obtain food and engage in activities, comprising the steps of:
(a) providing at least one menu item to enhance cognitive reserve,
(b) providing at least one physical activity to enhance cognitive reserve, and
(c) providing at least one mental activity to enhance cognitive reserve.

2. The method of claim 1 wherein said method is performed by a spa at a destination resort.

3. The method of claim 1 wherein said at least one menu item is identified on the menu as good for the brain.

4. The method of claim 1 wherein said at least one mental activity operates to increase processing speed of the brain.

5. The method of claim 1 wherein said at least one mental activity enhances memory.

6. A method for doing business performed by a business entity where people stay to obtain food and engage in activities, comprising the steps of:
(a) assessing the cognitive reserve of a person;
(b) suggesting activities that the person can do to enhance their cognitive reserve; and
(c) providing activities that allow the person to enhance their cognitive reserve.

7. The method of claim 6 wherein said activities that allow the person to enhance their cognitive reserve comprise at least one eating activity.

8. The method of claim 8 wherein said at least one eating activity comprises at least one element identified as good for the brain.

9. The method of claim 6 wherein said activities that allow the person to enhance their cognitive reserve comprise at least one physical activity which increases brain size.

10. The method of claim 6 wherein said activities that allow people to enhance their cognitive reserves comprise at least one mental activity which increases the ability of the brain to process information.

11. The method of claim 6 wherein said method is performed by a spa at a destination resort.

12. The method of claim 11 wherein said method is performed on people known to have suffered a neurodegenerative disease.

13. The method of claim 12, wherein said neurodegenerative disease is stroke.

14. The method of claim 12, wherein said neurodegenerative disease is dementia.

15. A method for doing business performed by a business entity where people stay to obtain food and to engage in activities, comprising the steps of:
(a) advising people about cognitive reserve,
(b) advising people how to increase their cognitive reserves, and
(c) providing activities that allow people to enhance their cognitive reserves.

16. The method of claim 15 wherein said method is performed by a spa at a destination resort.

17. The method of claim 15 wherein said activities that allow people to enhance their cognitive reserves comprise at least one eating activity.

18. The method of claim 17 wherein said at least one eating activity comprises elements identified as good for the brain.

19. The method of claim 15 wherein said activities that allow people to enhance their cognitive reserves comprise at least one physical activity designed to increase brain size.

20. The method of claim 15 wherein said activities that allow people to enhance their cognitive reserves comprise at least one mental activity designed to increase the ability of the brain to process information.
